(19) United States
(12) Patent Application Publication
(10) Pub. No.: US 2014/0176601 A1
(43) Pub. Date: Jun. 26, 2014

(54) SYNTHETIC IMAGE GENERATION APPARATUS, BROADCAST RECEIVING APPARATUS, AND SYNTHETIC IMAGE GENERATION METHOD

(71) Applicant: Panasonic Corporation, Osaka (JP)

(72) Inventor: Koji HAMASAKI, Hyogo (JP)

(73) Assignee: Panasonic Corporation, Osaka (JP)

(21) Appl. No.: 14/029,842

(22) Filed: Sep. 18, 2013

(30) Foreign Application Priority Data
Dec. 20, 2012 (JP) 2012-278678

(51) Int. Cl. H04N 5/445; G06T 11/60

(52) U.S. Cl. CPC H04N 5/445; G06T 11/60
USPC 345/629

(57) ABSTRACT

A synthetic image generation apparatus includes: a receiving unit which receives painting data from an input device; a synthesis unit which synthesizes a still image included in video content with the painting data received by the receiving unit, to generate a synthetic image; and a display control unit which selectively displays the video content and the synthetic image on a display device.

### CROSS REFERENCE TO RELATED APPLICATION

The present application is based on and claims priority of Japanese Patent Application No. 2012-278678 filed on Dec. 20, 2012. The entire disclosure of the above-identified application, including the specification, drawings and claims is incorporated herein by reference in its entirety.

### FIELD

One or more exemplary embodiments disclosed herein relate generally to synthetic image generation apparatuses which generate synthetic images.

### BACKGROUND

As an example, a conventional automatic picture generation apparatus generates a synthetic image by synthesizing a photographed image with a scribbled image painted by a user, and then transmits the generated synthetic image to an external terminal device (see Patent Literature 1, for example).

### CITATION LIST

### Patent Literature

[Patent Literature 1]
Japanese Unexamined Patent Application Publication No. 2008-103873

### SUMMARY

### Technical Problem

One non-limiting and exemplary embodiment provides a synthetic image generation apparatus which is capable of appropriately generating a synthetic image by synthesizing video content acquired via a broadcast or the like with painting data inputted by a user.

### Solution to Problem

In one general aspect, the techniques disclosed here feature a synthetic image generation apparatus including: a receiving unit which receives painting data from an input device; a synthesis unit which synthesizes a still image included in video content with the painting data received by the receiving unit, to generate a synthetic image; and a display control unit which selectively displays the video content and the synthetic image on a display device.

### Advantageous Effects

One or more exemplary embodiments of features disclosed herein provide a synthetic image generation apparatus which is capable of appropriately generating a synthetic image by synthesizing video content acquired via a broadcast or the like with painting data inputted by a user.

### BRIEF DESCRIPTION OF DRAWINGS

These and other objects, advantages and features in the present disclosure will become apparent from the following description thereof taken in conjunction with the accompanying drawings that illustrate a specific embodiment in the present disclosure.

FIG. 1 is an external view of a synthetic image generation system in Embodiment 1.

FIG. 2 is a block diagram showing a configuration of a synthetic image generation apparatus in Embodiment 1.

FIG. 3 is a flowchart showing an operation performed by the synthetic image generation apparatus in Embodiment 1.

FIG. 4 is a diagram showing a first example of a display screen of the synthetic image generation apparatus in Embodiment 1.

FIG. 5 is a diagram showing a second example of the display screen of the synthetic image generation apparatus in Embodiment 1.

FIG. 6 is a diagram showing a third example of the display screen of the synthetic image generation apparatus in Embodiment 1.

FIG. 7 is a diagram showing a fourth example of the display screen of the synthetic image generation apparatus in Embodiment 1.

FIG. 8 is a diagram showing an example of a setting area arranged in the display screen of the synthetic image generation apparatus in Embodiment 1.

FIG. 9 is a diagram showing an example of an arrangement of the setting area in the display screen of the synthetic image generation apparatus in Embodiment 1.

FIG. 10 is a diagram showing a first configuration example of a synthesis unit and a display control unit in Embodiment 1.

FIG. 11 is a diagram showing an example of synthetic image generation in Embodiment 1.

FIG. 12 is a diagram showing a second configuration example of the synthesis unit and the display control unit in Embodiment 1.

FIG. 13 is an external view of a synthetic image generation system in Embodiment 2.

FIG. 14 is a block diagram showing a configuration of a synthetic image generation apparatus in Embodiment 2.

FIG. 15 is a flowchart showing an operation performed by the synthetic image generation apparatus in Embodiment 2.

FIG. 16 is a diagram showing a first example of a display screen of the synthetic image generation apparatus and a display screen of a terminal device in Embodiment 2.

FIG. 17 is a diagram showing a second example of the display screen of the synthetic image generation apparatus and the display screen of the terminal device in Embodiment 2.

FIG. 18 is a diagram showing a third example of the display screen of the synthetic image generation apparatus and the display screen of the terminal device in Embodiment 2.

FIG. 19 is a diagram showing a fourth example of the display screen of the synthetic image generation apparatus and the display screen of the terminal device in Embodiment 2.

### DESCRIPTION OF EMBODIMENTS

### Underlying Knowledge Forming Basis of the Present Disclosure

In relation to the automatic picture generation apparatus disclosed in the Background section, the inventor has found the following problem.

The automatic picture generation apparatus disclosed in Patent Literature 1 adds a scribble to a still image shot by the present automatic picture generation apparatus. However, it is difficult to add painting data such as a scribble to video content such as real-time content. Moreover, it is also difficult to add painting data such as a scribble to video content stored in an external terminal device.

According to an exemplary embodiment disclosed herein, a synthetic image generation apparatus including: a receiving unit which receives painting data from an input device; a synthesis unit which synthesizes a still image included in video content with the painting data received by the receiving unit, to generate a synthetic image; and a display control unit which selectively displays the video content and the synthetic image on a display device.

With this, the synthetic image generation apparatus can appropriately generate a synthetic image from video content acquired via a broadcast or the like and painting data inputted by a user.

For example, the synthesis unit may synthesize the still image included in the video content currently being broadcasted with the painting data, to generate the synthetic image. The display control unit may selectively display the video content currently being broadcasted and the synthetic image on the display device.

With this, the synthetic image generation apparatus can add the painting data inputted by the user to the video content that is being broadcasted.

Moreover, for example, the receiving unit may repeatedly receive, from the input device, position information indicating a position in a screen of the display device, to receive the painting data indicating an image hand-painted using the input device. The synthesis unit may synthesize the still image with the painting data indicating the hand-painted image, to generate the synthetic image.

With this, the synthetic image generation apparatus can add the painting data inputted by the user through hand-painting to the video content.

Furthermore, for example, the display control unit may (i) perform effect processing on the video content and display, on the display device, the video content on which the effect processing has been performed, when the video content is to be displayed on the display device, and (ii) perform the effect processing on the synthetic image and display, on the display device, the synthetic image on which the effect processing has been performed, when the synthetic image is to be displayed on the display device. The synthesis unit may synthesize the still image with the painting data to generate the synthetic image, using the still image included in the video content on which the effect processing has not yet been performed.

With this, the synthetic image generation apparatus performs the synthesis processing before the effect processing. Thus, the synthetic image generation apparatus can display the synthetic image on the display device as in the case of the video content. In addition, the synthetic image generation apparatus can avoid the adverse effect that the effect processing is repeatedly applied.

Moreover, for example, the receiving unit may further receive, from the input device, a capture operation by which capturing is performed. The synthesis unit may (i) capture the still image from the video content, when the receiving unit receives the capture operation while the video content is being displayed, and (ii) synthesize the captured still image with the painting data received by the receiving unit, to generate the synthetic image. The display control unit may display the synthetic image generated by the synthesis unit, instead of the video content.

With this, the still image to be synthesized can be appropriately designated from the video content.

Furthermore, for example, the receiving unit may further receive, from the input device, a capture cancel operation by which capturing is canceled. The display control unit may display the video content instead of the synthetic image, when the receiving unit receives the capture cancel operation while the synthetic image is being displayed.

With this, instead of the displayed synthetic image, the video content can be displayed again.

Moreover, for example, the synthesis unit may capture the synthetic image from a synthetic video sequence obtained by synthesizing the video content with the painting data, to generate the synthetic image.

With this, the capture operation is performed after the video content and the painting data are synthesized. Thus, the still image to be synthesized can be determined after the video content and the painting data are synthesized.

Furthermore, for example, the synthetic image generation apparatus may further include a storage unit, wherein the synthesis unit may further store the generated synthetic image into the storage unit.

With this, the reproduced synthetic image can be stored. Therefore, it is possible to verify the synthetic image later.

Moreover, for example, the receiving unit may receive the painting data from the input device in a time series. The synthesis unit may further synthesize, in the time series, the video content with the painting data received by the receiving unit in the time series, to generate a synthetic video sequence. The display control unit may further display, on the display device, the synthetic video sequence generated by the synthesis unit.

With this, the synthetic image generation apparatus can process the video content as a video (video data) without any change, and synthesize the video content with the painting data received in a time series.

Furthermore, for example, the synthetic image generation apparatus may further include a storage unit. The receiving unit may receive the painting data from the input device in a time series and store, as painting video data, the painting data received in the time series into the storage unit in the time series. The synthesis unit may further synthesize the video content with the painting video data stored in the storage unit, to generate a synthetic video sequence. The display control unit may further display the synthetic video sequence generated by the synthesis unit on the display device.

With this, the synthetic image generation apparatus can process the video content as a video (video data) without any change, and synthesize the video content with the painting video data.

Moreover, for example, the synthetic image generation apparatus further includes an acquisition unit which acquires the video content from an external terminal device via a network. The synthesis unit may synthesize the still image included in the video content acquired by the acquisition unit with the painting data received by the receiving unit, to generate the synthetic image.

With this, the synthetic image generation apparatus can generate the synthetic image by synthesizing the video content stored in the external terminal device with the painting data.

Furthermore, for example, the synthesis unit may further output the generated synthetic image to the terminal device.

With this, the synthetic image generation apparatus can output the generated synthetic image to the external terminal device.

Moreover, for example, the receiving unit may further (i) receive, from the input device, a painting start operation by which painting is started, and (ii) receive position information indicating a position in a screen of the display device from the input device to receive the painting data corresponding to the position, after the painting start operation is received. The display control unit may arrange a setting area and a display area in the screen when the receiving unit receives the painting start operation, the setting area being used for setting information that configures the painting data, and the display area being used for displaying the video content.

With this, the synthetic image generation apparatus can arrange the setting area and the displaying area in the screen in the painting mode.

Furthermore, for example, the setting area may be used for setting, as the information that configures the painting data, information on at least one of a line, a color, and a sample image. The receiving unit may further (i) set the information on at least one of the line, the color, and the sample image by receiving, from the input device, the position information indicating the position in the setting area and (ii) receive the painting data configured with the set information.

With this, the synthetic image generation apparatus can receive, from the input device, the painting data that is appropriately set.

Moreover, for example, the display control unit may determine an arrangement position of the setting area according to the position information received from the input device, and arrange the setting area in the determined arrangement position.

With this, the synthetic image generation apparatus can arrange the setting area in an appropriate position in the screen according to the position information received from the input device.

Furthermore, for example, the receiving unit may receive the painting data from a plurality of input devices including the input device. The synthesis unit may synthesize the still image included in the video content with the painting data received by the receiving unit from the input devices, to generate the synthetic image.

With this, the synthetic image generation apparatus can receive the painting data from the plurality of input devices.

Moreover, for example, the synthetic image generation apparatus may further include the input device.

With this, the synthetic image generation apparatus can be used as an integrated synthetic image generation apparatus including the input device.

Furthermore, for example, the synthetic image generation apparatus may further include the display device.

With this, the synthetic image generation apparatus can be used as an integrated synthetic image generation apparatus including the display device.

Moreover, according to an exemplary embodiment disclosed herein, a broadcast receiving apparatus may include: the synthetic image generation apparatus; and a tuner which acquires the video content, by receiving a digital television broadcast signal and demodulating the received digital television broadcast signal.

With this, the synthetic image generation apparatus can be used as a broadcast receiving apparatus which is capable of generating a synthetic image.

These general and specific aspects may be implemented using a system, a method, an integrated circuit, a computer program, or a non-transitory computer-readable recording medium such as a CD-ROM, or any combination of systems, methods, integrated circuits, computer programs, or computer-readable recording media.

Hereinafter, certain exemplary embodiments are described in greater detail, with reference to the accompanying Drawings as necessary. However, a detailed description that is more than necessary may be omitted. For example, a detailed description on a well-known matter may be omitted, and an explanation on structural elements having the substantially same configuration may not be repeated. With this, unnecessary redundancy can be avoided in the following description, which makes it easier for those skilled in the art to understand.

It should be noted that the inventor provides the accompanying drawings and the following description in order for those skilled in the art to fully understand the present disclosure. Thus, the accompanying drawings and the following description are not intended to limit the subject matter disclosed in the scope of Claims.

### Embodiment 1

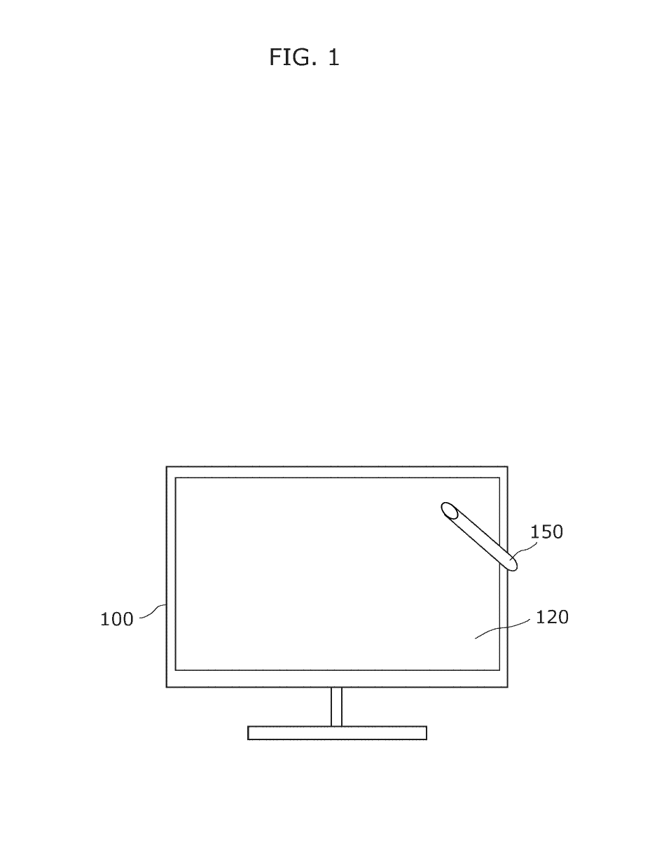

FIG. 1 is an external view of a synthetic image generation system in Embodiment 1. As shown in FIG. 1, the synthetic image generation system includes a synthetic image generation apparatus 100 and an input device 150. The synthetic image generation system generates a synthetic image by synthesizing painting data that a user inputs using the input device 150 with video content. The synthetic image generation apparatus 100 is implemented as a broadcast receiving apparatus such as a plasma display panel television or a liquid crystal display television.

The input device 150 is a touch pen for example, and is used for operating the synthetic image generation apparatus 100. To be more specific, the user performs an operation on a display screen 120 of the synthetic image generation apparatus 100 using the input device 150. The input device 150 detects a position on the display screen 120 of the synthetic image generation apparatus 100 or an operation performed on the display screen 120 of the synthetic image generation apparatus 100. Then, the input device 150 transmits, for example, the detected position information or the detected operation information to the synthetic image generation apparatus 100 using short-range wireless communications such as Bluetooth.

Examples of the operation performed on the display screen 120 of the synthetic image generation apparatus 100 include “tap” which means to touch the display screen 120 with the tip of the touch pen serving as the input device 150 and then immediately move the pen tip off the display screen 120. The examples further include “hold/release” which means to keep touching the display screen 120 with the pen tip and then move the pen tip off the display screen 120, and “drag/drop” which means to move the pen tip while keep touching the display screen 120 with the pen tip and then move the pen tip off the display screen 120.

When the input device 150 detects a position on the display screen 120, the synthetic image generation system firstly causes the display screen 120 to emit light to transmit a start signal (blinks four times at intervals of 30 milliseconds, for example) to the input device 150. After this, the synthetic image generation system performs scanning on the display screen 120 in each of X and Y directions. The input device 150 detects the scanning operation performed in each of the X and Y directions.

Then, the input device 150 can detect the position on the basis of a time between the detection of the start signal and the detection of the scanning operation.

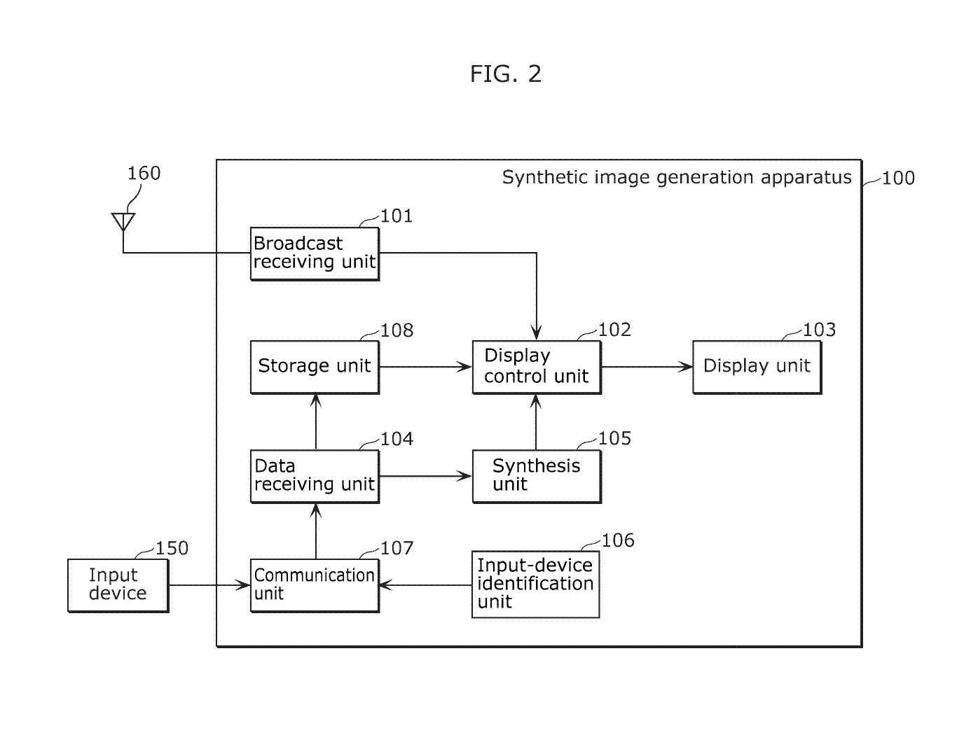

FIG. 2 is a block diagram showing a configuration of the synthetic image generation apparatus 100 in Embodiment 1. The synthetic image generation apparatus 100 generates a synthetic image, and includes a broadcast receiving unit 101, a display control unit 102, a display unit 103, a data receiving unit 104, a synthesis unit 105, an input-device identification unit 106, a communication unit 107, and a storage unit 108 as shown in FIG. 2.

The broadcast receiving unit 101 is a tuner that receives a digital television broadcast signal via an antenna 160 and demodulates the received digital television broadcast signal. Moreover, the broadcast receiving unit 101 outputs the demodulated digital television broadcast signal as video content.

The display control unit 102 is a controller that selectively displays the video content, the synthetic image, or the like on the display unit 103. To be more specific, the display control unit 102 displays one of the video content, the synthetic image, and the like on the display unit 103.

More specifically, the display control unit 102 switches, for example, between: a normal mode where video content or the like that is currently being broadcasted via digital television broadcasting is displayed on the display unit 103; and a painting mode where painting data painted by the user using the input device 150 is displayed on the display unit 103. In the normal mode, the display control unit 102 displays the video content outputted from the broadcast receiving unit 101 or the video content stored in the storage unit 108, for example.

On the other hand, in the painting mode, the display control unit 102 arranges a setting area for setting information that configures the painting data in the display unit 103 (i.e., in the display screen 120) in addition to a display area for displaying the video content displayed in the normal mode. Moreover, the display control unit 102 displays a synthetic image generated by the synthesis unit 105 on the display unit 103.

The display control unit 102 may display the synthetic image that is generated by the synthesis unit 105 and is already stored in the storage unit 108, on the display unit 103 in the painting mode or the normal mode.

The display unit 103 is a display device that displays video content, a synthetic image, or the like. The display unit 103 is, for example, a plasma display or a liquid crystal display, and includes the display screen 120.

The data receiving unit 104 is a receiver that receives the operation information, the position information, the painting data, and the like from the input device 150 via the communication unit 107. For example, the data receiving unit 104 receives, as a painting start operation, an operation by which the display screen 120 of the display unit 103 is pressed for a few seconds with the tip of the touch pen serving as the input device 150. Then, when receiving the painting start operation, the data receiving unit 104 transmits an instruction to activate the painting mode to the display control unit 102 and the synthesis unit 105.

Moreover, in the painting mode, the data receiving unit 104 receives, from the input device 150, the painting data on a picture (an image) painted on the display screen 120 by the user using the input device 150. Here, the data receiving unit 104 uses, as the painting data, a line type and a color to be set in the setting area. Furthermore, the data receiving unit 104 may receive, as the painting data, a sample image to be set in the setting area from the input device 150.

Moreover, in the painting mode, the data receiving unit 104 receives, from the input device 150, a capture operation to capture an image or a capture cancel operation to cancel the captured image. Here, the data receiving unit 104 transmits a capture instruction or a capture cancel instruction to the display control unit 102 and the synthesis unit 105.

The synthesis unit 105 is a synthesizer that synthesizes a plurality of images. The synthesis unit 105 synthesizes the still image included in the video content with the painting data received by the data receiving unit 104, to generate a synthetic image.

To be more specific, when receiving the instruction to activate the painting mode from the data receiving unit 104 or when receiving the capture instruction from the data receiving unit 104 in the painting mode, the synthesis unit 105 captures an image (a still image) to be synthesized (referred to as the to-be-synthesized image hereafter) from the video content currently being displayed on the display unit 103. After this, the synthesis unit 105 synthesizes the to-be-synthesized image with the painting data received by the data receiving unit 104, to generate a synthetic image.

Moreover, when receiving the capture cancel instruction from the data receiving unit 104 in the painting mode, the synthesis unit 105 cancels the captured to-be-synthesized image.

The input-device identification unit 106 is an identification device that identifies an input device.

To be more specific, the input-device identification unit 106 previously registers, into the storage unit 108 for example, the input device 150 capable of entering the painting data. Then, the input-device identification unit 106 verifies whether or not the painting data received by the communication unit 107 is transmitted from the input device 150 that has been registered. Only when the painting data received by the communication unit 107 is transmitted from the input device 150 that has been registered, the input-device identification unit 106 performs control to cause the communication unit 107 to output the painting data to the data receiving unit 104.

The communication unit 107 is a communicator that communicates with the input device 150 using short-range wireless communications such as Bluetooth.

The storage unit 108 is storage such as a memory, a hard disk, or a memory card, and is used for storing the video content, the synthetic image generated by the synthesis unit 105, and the like.

Next, an operation performed by the synthetic image generation apparatus 100 configured as described thus far is explained.

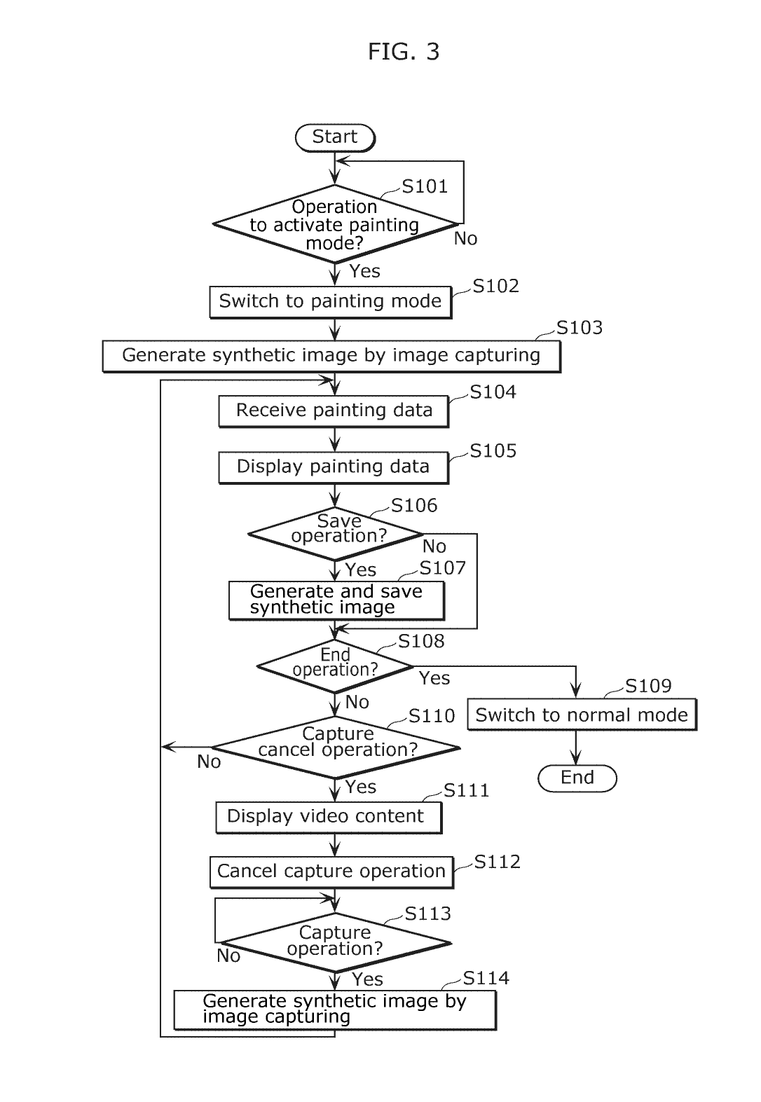

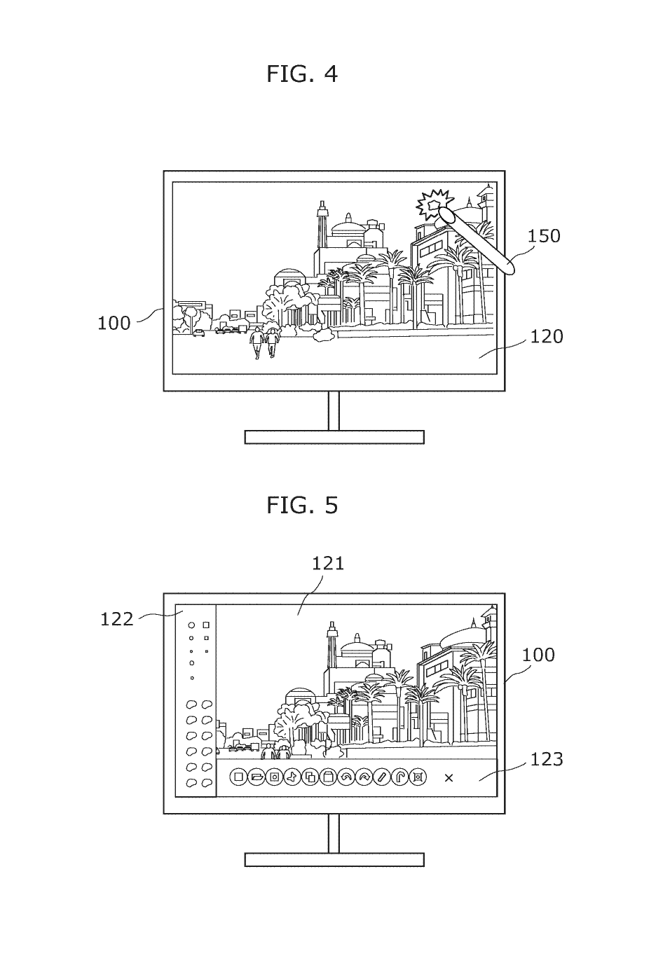

FIG. 3 is a flowchart showing the operation performed by the synthetic image generation apparatus 100 in Embodiment 1. Moreover, each of FIG. 4 to FIG. 7 shows an example of the display screen 120 of the synthetic image generation apparatus 100 in Embodiment 1. It should be noted that, in the following description, the operation is performed using the input device 150 that has been previously registered by the input-device identification unit 106. Moreover, in the following description, the video content that is currently being broadcasted via digital television broadcasting is initially displayed on the display unit 103 in the normal mode.

Firstly, the data receiving unit 104 determines whether or not the operation to activate the painting mode is performed, by determining, for example, whether or not the display screen 120 is pressed for a few seconds with the tip of the touch pen serving as the input device 150 (Step S101). When the display screen 120 is not pressed for a few seconds by the pen tip (NO in Step S101), the data receiving unit 104 performs nothing in particular. In other words, the video content via digital television broadcasting remains to be displayed on the display screen 120 in the normal mode.

On the other hand, when the display screen 120 is pressed for a few seconds with the pen tip as shown in FIG. 4 (YES in Step S101), the data receiving unit 104 transmits the instruction to activate the painting mode to the display control unit 102 and the synthesis unit 105. When receiving the instruction to activate the painting mode from the data receiving unit 104, the display control unit 102 switches the display mode from the normal mode to the painting mode (Step S102). More specifically, the display control unit 102 displays the video content displayed in the normal mode in a display area 121, as shown in FIG. 5.

Moreover, the display control unit 102 arranges the setting area for setting the information that configures the painting data in the display screen 120. Here, the setting area includes: a palette 122 for setting a line type, a color, a sample image, and so forth; and a toolbar 123 for performing editing operations such as copy, cut, paste, capture, capture cancel, save, and end.

When receiving the instruction to active the painting mode from the data receiving unit 104, the synthesis unit 105 generates a to-be-synthesized image by capturing the to-be-synthesized image from the video content currently being displayed on the display unit 103 (Step S103). Here, the display control unit 102 displays the to-be-synthesized image (the still image) captured by the synthesis unit 105 in the display area 121. To be more specific, immediately after the display mode is switched to the painting mode, the still image instead of the video is displayed in the display area 121.

After the display mode is switched to the painting mode, the data receiving unit 104 receives, from the input device 150, the painting data on a painting (an image) painted on the display screen 120 by the user using the input device 150. Here, the data receiving unit 104 receives, from the input device 150, the painting data configured with the line type and the color that are set using the palette 122 (Step S104).

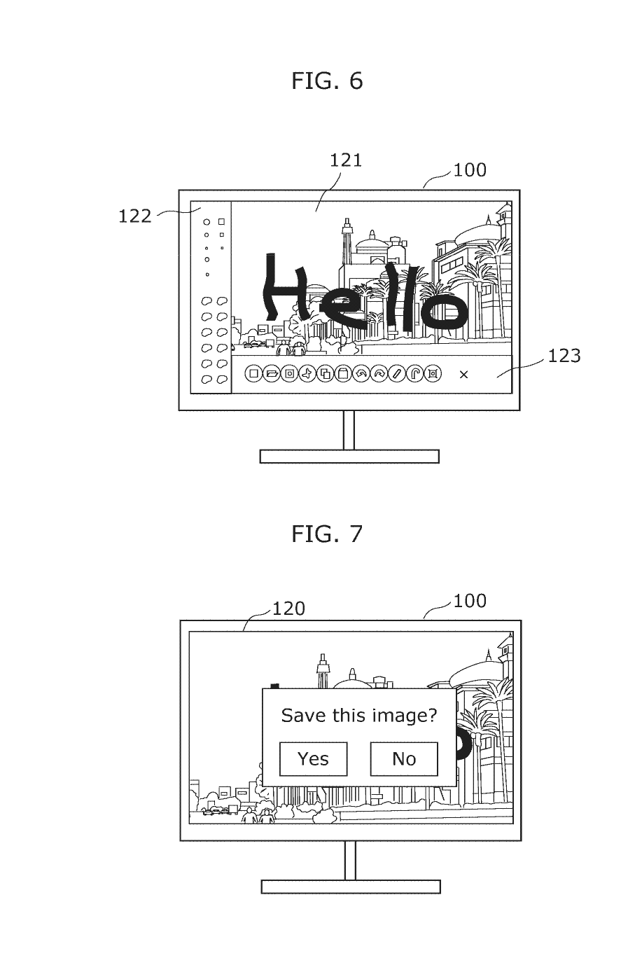

For example, as shown in FIG. 6, the display control unit 102 superimposes the painting data received by the data receiving unit 104 (“Hello” in the example shown in FIG. 6) on the to-be-synthesized image in the display area 121 (Step S105).

The data receiving unit 104 determines whether or not a save operation is received, by determining whether or not the “save” icon in the toolbar 123 is tapped with the input device 150 (Step S106). When the save operation is not received (NO in Step S106), the data receiving unit 104 performs nothing in particular.

On the other hand, when receiving the save operation (YES in Step S106), the data receiving unit 104 transmits a save instruction to the display control unit 102. When receiving the save instruction from the data receiving unit 104, the display control unit 102 displays a message to confirm the save operation on the display screen 120 as shown in FIG. 7. Here, when the save operation is carried on, the synthesis unit 105 synthesizes the to-be-synthesized image with the painting data received by the data receiving unit 104 to generate the synthetic image, and then saves the synthetic image into the storage unit 108 (Step S107).

Next, the data receiving unit 104 determines whether or not an end operation is received, by determining whether or not the “end” icon in the toolbar 123 is tapped with the input device 150 (Step S108).

When receiving the end operation (YES in Step S108), the data receiving unit 104 transmits an end instruction to the display control unit 102. When receiving the end instruction from the data receiving unit 104, the display control unit 102 switches the display mode from the painting mode to the normal mode (Step S109). To be more specific, the display control unit 102 displays the video content that is currently being broadcasted via digital television broadcasting, on the display screen 120 in the normal mode as shown in FIG. 4.

On the other hand, when the end operation is not received (NO in Step S108), the data receiving unit 104 determines whether or not a capture cancel operation is received (Step S110). To be more specific, the data receiving unit 104 determines whether or not the capture cancel operation is received, by determining whether or not the “capture cancel” icon in the toolbar 123 is tapped with the input device 150.

When the capture cancel operation is not received (NO in Step S110), the data receiving unit 104 performs nothing in particular. Then, the data receiving unit 104 returns to receive the painting data again (Step S104). More specifically, the synthetic image generation apparatus 100 remains to receive the painting data from the input device 150 in the painting mode.

On the other hand, when receiving the capture cancel operation (YES in Step S110), the data receiving unit 104 transmits the capture cancel instruction to the display control unit 102 and the synthesis unit 105. In this case, the display control unit 102 displays, in the display area 121, the video content displayed in the normal mode before the display mode is switched to the painting mode (Step S111). Moreover, in this case, the synthesis unit 105 cancels the captured to-be-synthesized image (Step S112).

For example, when wishing to change the to-be-synthesized image captured when the painting mode is activated to a different image, the user selects the “capture cancel” icon using the input device 150. After this, the user taps the “capture” icon in the toolbar 123 with the input device 150 when a desired image with which the user wishes to synthesize the painting data is displayed in the display area 121 where the video content is being displayed. As a result, the desired image with which the painting data is to be synthesized is captured.

Next, the data receiving unit 104 determines whether or not a capture operation is received, by determining whether or not the “capture” icon in the toolbar 123 is tapped with the input device 150 (Step S113). When the capture operation is not received (NO in Step S113), the data receiving unit 104 performs nothing in particular. More specifically, the data receiving unit 104 waits for a capture operation while the video content is being displayed in the painting mode.

It should be noted that, in the flowchart shown in FIG. 3, the data receiving unit 104 does not receive the painting data until an image is captured. However, the operation mode is not limited to this. For example, before an image is captured, the data receiving unit 104 may receive the painting data and the capture operation from the input device 150 while the video content is being displayed in the painting mode.

On the other hand, when receiving the capture operation (YES in Step S113), the data receiving unit 104 transmits the capture instruction to the display control unit 102 and the synthesis unit 105.

Upon receiving the capture instruction, the synthesis unit 105 generates a to-be-synthesized image by capturing the to-be-synthesized still image from the video content that is currently being displayed in the display unit 103 (Step S114). Following this, the synthesis unit 105 receives the painting data (Step S104). In this case, the display control unit 102 displays the to-be-synthesized image (the still image) captured by the synthesis unit 105 in the display area 121.

As described thus far, the synthetic image generation apparatus 100 captures the to-be-synthesized still image from, for example, the video content that is currently being broadcasted via digital television broadcasting or the video content stored in the storage unit 108. Then, the synthetic image generation apparatus 100 generates the synthetic image by synthesizing the captured still image with the painting data received by the data receiving unit 104. Accordingly, the synthetic image generation apparatus 100 can appropriately generates the synthetic image from the video content and the painting data.

In the above configuration, the synthetic image generation system includes a single input device 150. However, the number of input devices included in the synthetic image generation system is not limited to this. For example, the synthetic image generation system may include two or more input devices. With this, two or more users can simultaneously paint images or the like on video content using the two or more input devices.

For example, in this case, the input-device identification unit 106 previously registers the two or more input devices capable of entering the painting data into, for instance, the storage unit 108. Then, when the painting data is received, the input-device identification unit 106 identifies the input device that enters the present painting data. Only when the input device is previously registered, the input-device identification unit 106 may perform control to cause the communication unit 107 to output the entered painting data to the data receiving unit 104.

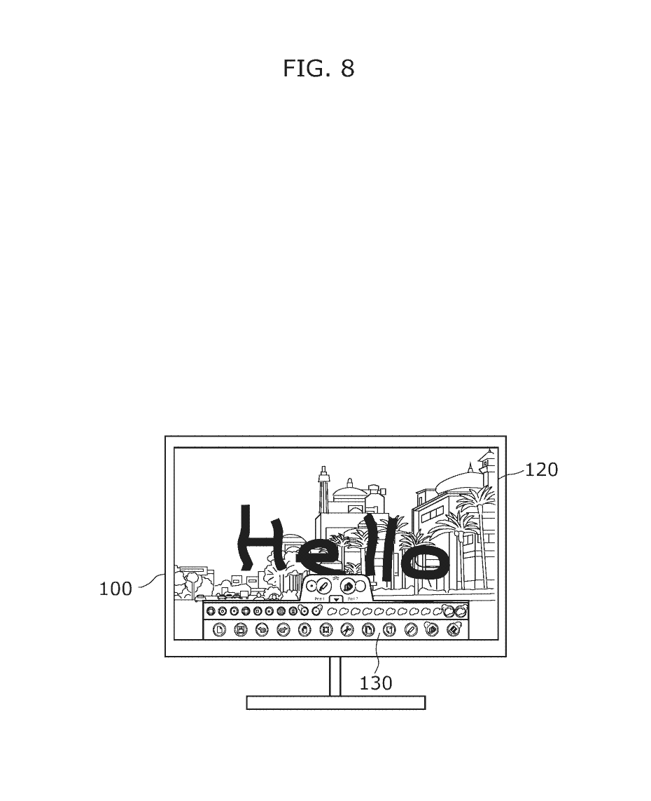

FIG. 8 shows a variation of the setting area to be arranged in the display screen 120. The setting area shown in FIG. 8 is to be used by the two input devices.

For example, when the painting data is to be received from the two input devices, the display control unit 102 displays a panel 130 including a palette, a toolbar, and a status bar on the display screen 120. The palette is an area for setting a line type, a color, a sample image, and so forth. The toolbar is an area for performing editing operations such as copy, cut, paste, capture, capture cancel, save, and end. The status bar is an area for showing the statuses of the two input devices.

It should be noted that the status bar displayed in the panel 130 shown in FIG. 8 is merely an example. The status bar showing the statuses of the two input devices may be added to the palette 122 or the toolbar 123 shown in FIG. 5. Moreover, even when only one of the input devices 150 is used, the status of the input device 150 may be displayed in the display screen 120 in the same manner as shown by the panel 130 in FIG. 8.

Moreover, in the above configuration, the arrangement position of the setting area (including the palette 122, the toolbar 123, and the panel 130) is fixed in the display screen 120. However, the arrangement position of the setting area is not limited to this.

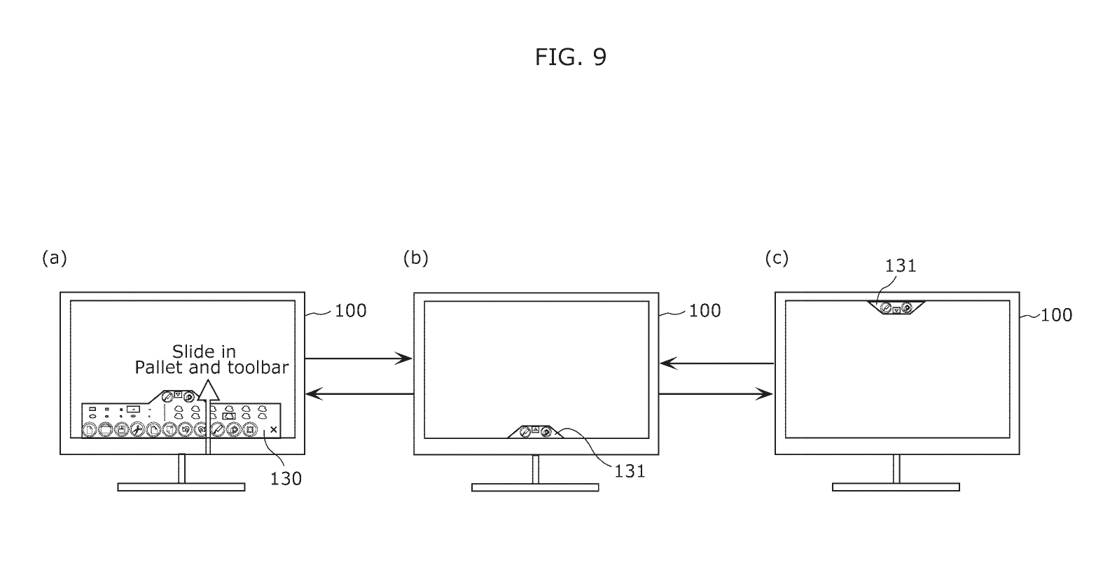

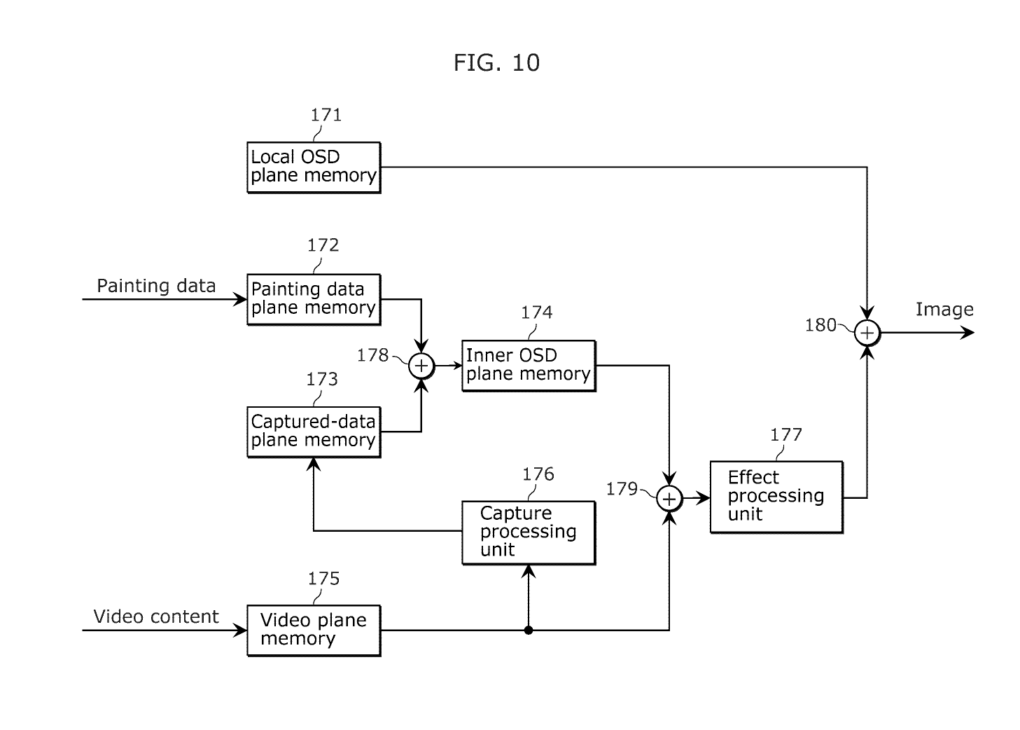

For example, the manner in which the panel 130 is displayed as shown in (a) of FIG. 9 may be switched to the manner in which only the status bar 131 showing the statuses of the two input devices is displayed out of the panel 130 as shown in (b) of FIG. 9. In this case, only the status bar 131 may be displayed as shown in (b) of FIG. 9 in normal times, and the panel 130 may be displayed as shown in (a) of FIG. 9 when the status bar 131 is tapped.

The arrangement position of the panel 130 and the status bar 131 is not limited to the lower part of the display screen 120 as shown in (a) and (b) of FIG. 9, and the panel 130 and the status bar 131 may be arranged in an upper part of the display screen 120 as shown in (c) of FIG. 9. Moreover, the panel 130 and the status bar 131 may be arranged in a right-hand or left-hand part of the display screen 120. Furthermore, the arrangement position of the panel 130 and the status bar 131 in the display screen 120 may be determined according to position information received from the input device.

Moreover, before effect processing is performed on the video content, the synthesis unit 105 may capture the to-be-synthesized still image from the video content. Then, the synthesis unit 105 may perform the effect processing on the synthetic image obtained as a result of synthesizing the captured still image with the painting data. The following describes a relationship between the synthesis processing and the effect processing with reference to FIG. 10.

FIG. 10 is a diagram showing a concrete example of a configuration of the synthesis unit 105 and the display control unit 102. Each of structural elements shown in FIG. 10 may be included in the synthesis unit 105 or the display control unit 102. Alternatively, a control unit including the synthesis unit 105 and the display control unit 102 may include the structural elements shown in FIG. 10.

A local OSD plane memory 171 stores an image and the like to be used for on-screen display (OSD). The image stored in the local OSD plane memory 171 is displayed on the display screen 120 without the effect processing. For example, a menu image used for setting a display format, an operation, or the like of the display unit 103 is stored in the local OSD plane memory 171.

A painting data plane memory 172 stores the painting data. The data receiving unit 104 stores the painting data received by the communication unit 107 into the painting data plane memory 172.

A captured-data plane memory 173 stores the captured to-be-synthesized still image. The captured-data plane memory 173 may store an image including the display area and the setting area.

An inner OSD plane memory 174 stores an image used for OSD, as with the local OSD plane memory 171. Note that, however, the effect processing is performed on the image stored in the inner OSD plane memory 174. For example, the inner OSD plane memory 174 stores an image (textual information) to be superimposed upon the video content.

A video plane memory 175 stores video content. For example, the broadcast receiving unit 101 sequentially stores the frames of the demodulated video content into the video plane memory 175 to update the frames stored in the video plane memory 175.

Alternatively, the video plane memory 175 may store, for example, the frames of the video content stored in the storage unit 108 or the synthetic image stored in the storage unit 108.

A capture processing unit 176 captures the to-be-synthesized still image from the video content. To be more specific, the capture processing unit 176 captures a still image (a frame) from the video plane memory 175 according to, for example, the capture operation. Then, the capture processing unit 176 stores the captured still image into the captured-data plane memory 173.

An effect processing unit 177 performs the effect processing on an image outputted from a superimposition unit 179. The effect processing includes a sharpening process, a smoothing process, a luminance adjusting process, and a color adjusting process. The image (pixel value) is adjusted by the effect processing.

The superimposition unit 178 superimposes the image obtained from the painting data plane memory 172 on the image obtained from the captured-data plane memory 173. Then, the superimposition unit 178 stores the image obtained as a result of the superimposition into the inner OSD plane memory 174.

The superimposition unit 179 superimposes the image obtained from the inner OSD plane memory 174 on the image obtained from the video plane memory 175. Then, the superimposition unit 179 outputs the image obtained as a result of the superimposition to the effect processing unit 177.

A superimposition unit 180 superimposes the image obtained from the local OSD plane memory 171 on the image on which the effect processing has been performed by the effect processing unit 177. Then, the superimposition unit 180 outputs the image obtained as a result of the superimposition to the display unit 103.

With the configuration shown in FIG. 10, the synthesis unit 105 and the display control unit 102 generate the synthetic image from the video content and the painting data and display the synthetic image on the display unit 103. In particular, with the configuration shown in FIG. 10, before the effect processing is performed on the video content, the to-be-synthesized still image is captured from the video content. Thus, the synthesis processing to synthesize the video content with the painting data is performed before the effect processing. On this account, the effect processing is prevented from being repeatedly performed on the image.

Moreover, as is the case with the original video content, the captured image and the synthetic image are displayed on the display unit 103 via the effect processing. Therefore, a sense of discomfort caused depending on whether or not the effect processing is performed can be reduced.

According to the synthesis method described above, the to-be-synthesized still image is captured from the video content and then the captured still image and the painting data are synthesized. However, the synthesis method is not limited to this.

For example, the video content may be processed as a video (i.e., video data) without any change, and then the video data and the painting data may be synthesized. In this case, the synthesis unit 105 generates painting video data by storing, in a time series, the painting data received by the data receiving unit 104 into the storage unit 108. Moreover, the synthesis unit 105 stores the video content into the storage unit 108 in association with the painting video data.

When reproduction is requested by the user, the synthesis unit 105 synthesizes the painting video data with the video content to generate a synthesized video sequence. Then, the display control unit 102 displays the synthetic video sequence generated by the synthesis unit 105 on the display unit 103.

Moreover, the synthesis unit 105 may synthesize, in a time series, the video content with the painting data received in a time series by the data receiving unit 104 to generate the synthetic video sequence, without separately storing the video content and the painting video data into the storage unit 108. Then, the synthesis unit 105 may store the generated synthetic video sequence into the storage unit 108.

Moreover, the synthesis unit 105 may capture a synthetic image from the synthetic video sequence obtained by synthesizing the video content with the painting data, and then may store the captured synthetic image into the storage unit 108.

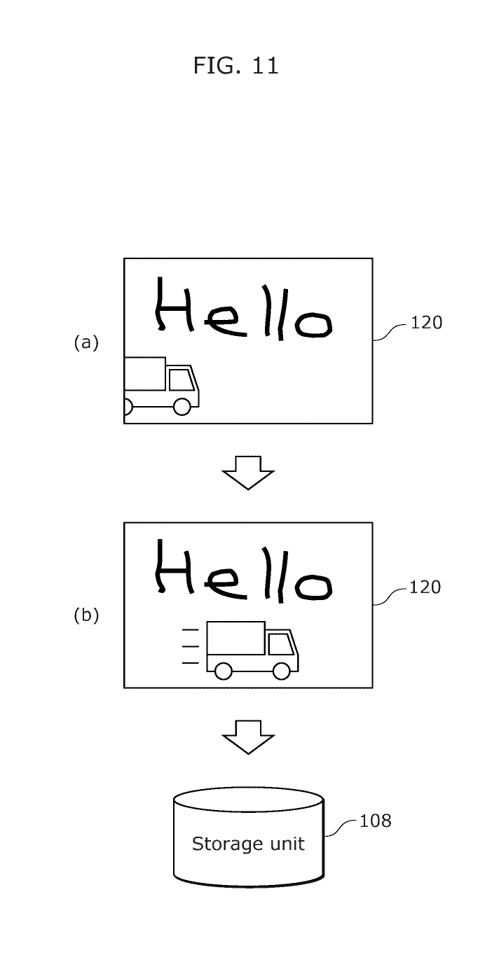

FIG. 11 is a diagram showing an example where the synthetic image generation apparatus 100 captures a synthetic image from a synthetic video sequence. In the example shown in FIG. 11, the still image is not captured from the video content, and the synthetic video sequence obtained by synthesizing the video content showing a moving truck with the painting data showing the letters “Hello” is displayed on the display screen 120 ((a) and (b) of FIG. 11). Although the painting data is not edited in the example shown in FIG. 11, the user may edit the painting data using the input device 150.

Then, the user may save one scene out of the synthetic video sequence as the synthetic image at desired timing. In the example of FIG. 11, the image shown in (b) is stored into the storage unit 108. To be more specific, in the present example, the to-be-synthesized still image is to be selected later instead of being first captured. Therefore, the user does not need to first decide the still image and thus may easily start painting.

In the above example, especially when the video content can be repeatedly reproduced or when the video content can be rewound and then reproduced, the user can appropriately select the still image matching the painting data from the video content.

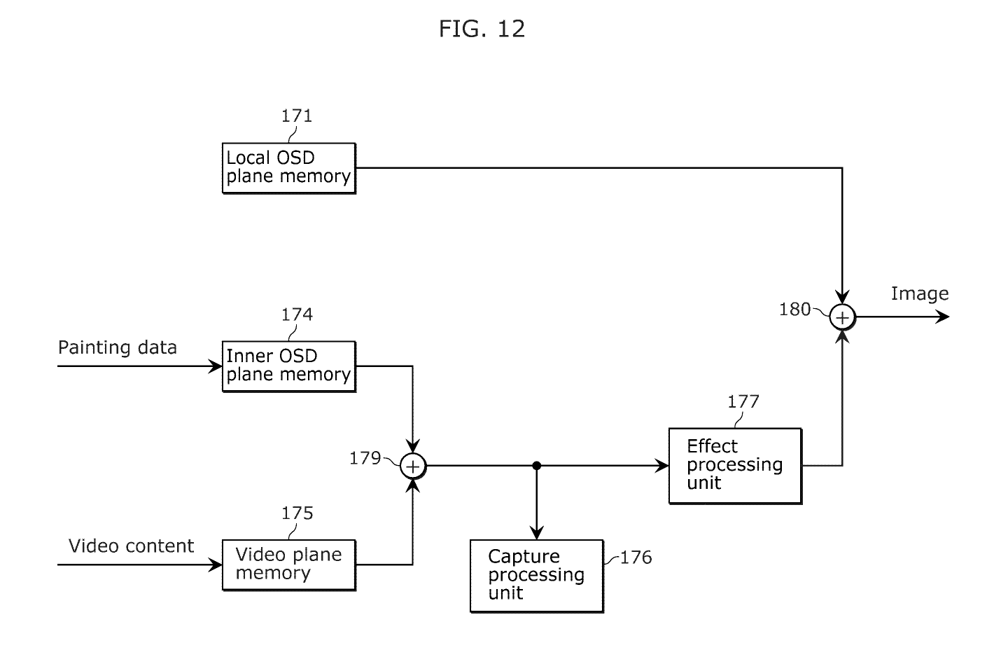

FIG. 12 is a diagram showing an example of a concrete configuration of the synthesis unit 105 and the display control unit 102 corresponding to the above operation.

In the example shown in FIG. 12, the painting data plane memory 172 and the captured-data plane memory 173 are omitted as compared with the example shown in FIG. 10. The painting data is directly stored into the inner OSD plane memory 174. Then, the superimposition unit 179 superimposed the painting data obtained from the inner OSD plane memory 174 on the video content obtained from the video plane memory 175. As a result, the painting data is dynamically superimposed on the video content.

The capture processing unit 176 captures the image obtained from the superimposition unit 179 and stores the captured image into the storage unit 108, according to the operation performed using the input device 150.

With the configuration shown in FIG. 12, the synthesis unit 105 and the display control unit 102 synthesize the video content with the painting data to generate the synthetic video sequence, and display the synthetic video sequence on the display unit 103. Then, the synthesis unit 105 (the capture processing unit 176) captures a desired synthetic image from the synthetic video sequence, and stores the captured synthetic image into the storage unit 108. Thus, the user can easily start painting and obtain the desired synthetic image. It should be noted that the configuration shown in FIG. 10 and the configuration shown in FIG. 12 may be combined.

### Embodiment 2

The synthetic image generation apparatus 100 in Embodiment 1 synthesizes the video content currently being broadcasted via digital television broadcasting or the video content stored in the storage unit with the painting data. In Embodiment 2, video content stored in an external terminal device and painting data are synthesized.

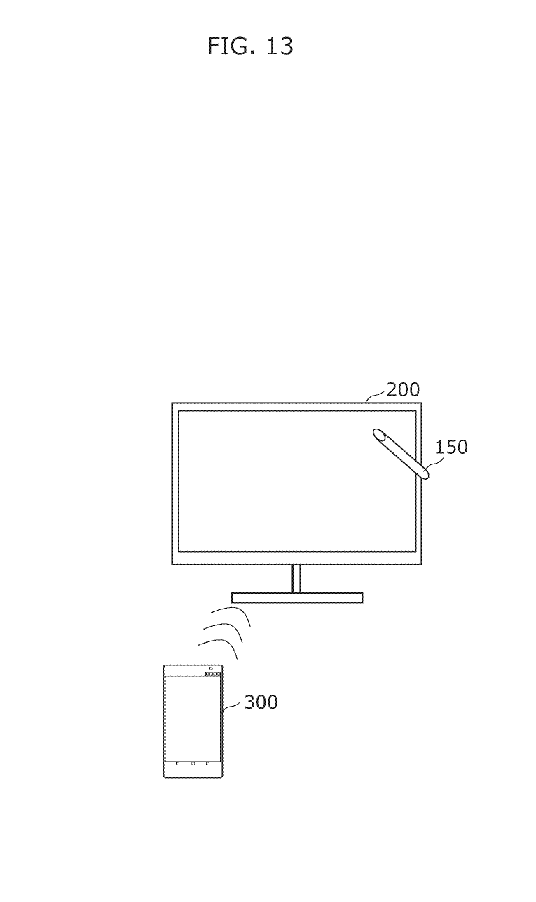

FIG. 13 is an external view of a synthetic image generation system in Embodiment 2. As shown in FIG. 13, the synthetic image generation system includes a synthetic image generation apparatus 200, an input device 150, and a terminal device 300. The synthetic image generation system generates a synthetic image by synthesizing painting data that a user inputs using the input device 150 with video content. The synthetic image generation apparatus 200 is implemented as a plasma display panel television, a liquid crystal display television, or the like.

The input device 150 is a touch pen for example, and is used for operating the synthetic image generation apparatus 200. To be more specific, the user performs an operation on a display screen 120 of the synthetic image generation apparatus 200 using the input device 150. The input device 150 detects a position on the display screen 120 of the synthetic image generation apparatus 200 or an operation performed on the display screen 120 of the synthetic image generation apparatus 200. Then, the input device 150 transmits, for example, the detected position information or the detected operation information to the synthetic image generation apparatus 200 using short-range wireless communications such as Bluetooth.

The terminal device 300 is, for example, a smartphone or a tablet terminal, and stores video content.

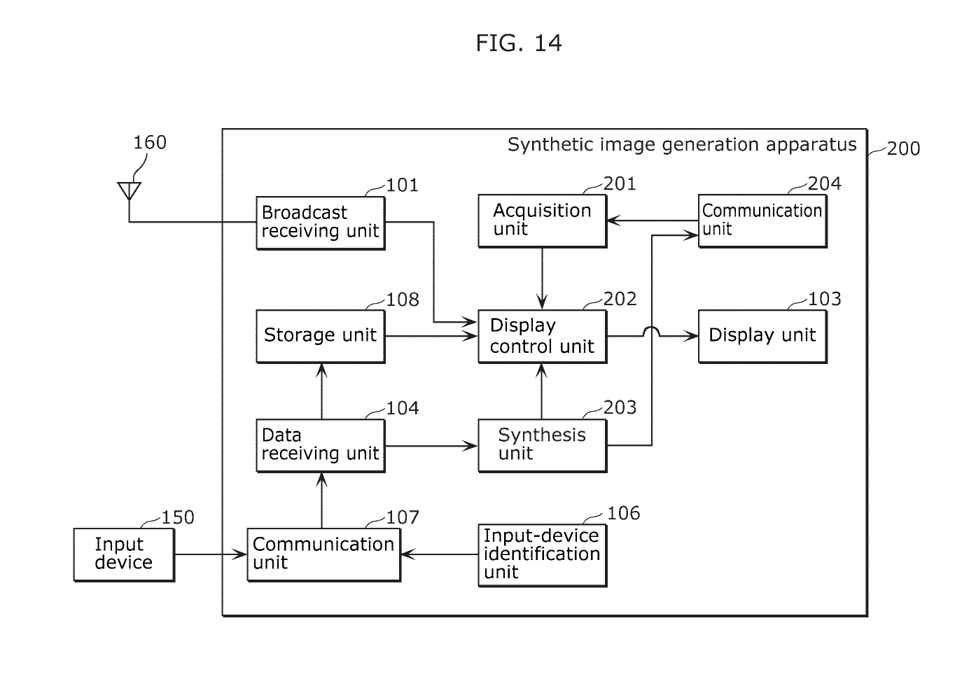

FIG. 14 is a block diagram showing a configuration of a synthetic image generation apparatus 200 in Embodiment 2. It should be noted that structural elements identical to those in Embodiment 1 are assigned the same reference signs used in Embodiment 1 and the explanations of these structural elements are not repeated in Embodiment 2.

The synthetic image generation apparatus 200 generates a synthetic image, and includes a broadcast receiving unit 101, an acquisition unit 201, a display control unit 202, a display unit 103, a data receiving unit 104, a synthesis unit 203, an input-device identification unit 106, a communication unit 107, a communication unit 204, and a storage unit 108 as shown in FIG. 14.

The acquisition unit 201 is an acquisition device that acquires data. To be more specific, the acquisition unit 201 acquires video content from the external terminal device 300 via the communication unit 204. Moreover, the acquisition unit 201 receives a synthetic image transfer request from the external terminal device 300 via the communication unit 204.

The display control unit 202 is a controller that displays the video content, the synthetic image, or the like on the display unit 103. The display control unit 202 switches, for example, between: a normal mode where video content or the like that is currently being broadcasted via digital television broadcasting is displayed; and a painting mode where the user paints an image or the like using the input device 150.

In the normal mode, the display control unit 202 displays, on the display unit 103, the video content acquired from the terminal device 300, the video content outputted from the broadcast receiving unit 101, or the video content stored in the storage unit 108, for example. In particular, when the acquisition unit 201 acquires the video content from the terminal device 300, the display control unit 202 displays the video content acquired from the terminal device 300 on the display unit 103.

On the other hand, in the painting mode, the display control unit 202 arranges a setting area for setting information that configures the painting data in the display unit 103 (i.e., in the display screen 120) in addition to a display area for displaying the video content displayed in the normal mode. Moreover, the display control unit 202 displays a synthetic image generated by the synthesis unit 203 on the display unit 103.

The synthesis unit 203 is a synthesizer that synthesizes a plurality of images. To be more specific, when receiving the instruction to activate the painting mode from the data receiving unit 104 or when receiving a capture instruction from the data receiving unit 104 in the painting mode, the synthesis unit 203 captures a to-be-synthesized still image from the video content currently being displayed on the display unit 103. After this, the synthesis unit 203 synthesizes the to-be-synthesized image with the painting data received by the data receiving unit 104, to generate a synthetic image.

Moreover, when receiving a capture cancel instruction from the data receiving unit 104 in the painting mode, the synthesis unit 203 cancels the captured to-be-synthesized image. After this, the synthesis unit 203 may generate a synthetic video sequence from the video content and the painting data received by the data receiving unit 104.

The communication unit 204 is a communicator that communicates with the terminal device 300 using wireless communications such as a wireless local area network (wireless LAN).

Next, an operation performed in the painting mode by the synthetic image generation apparatus 200 configured as described thus far is explained.

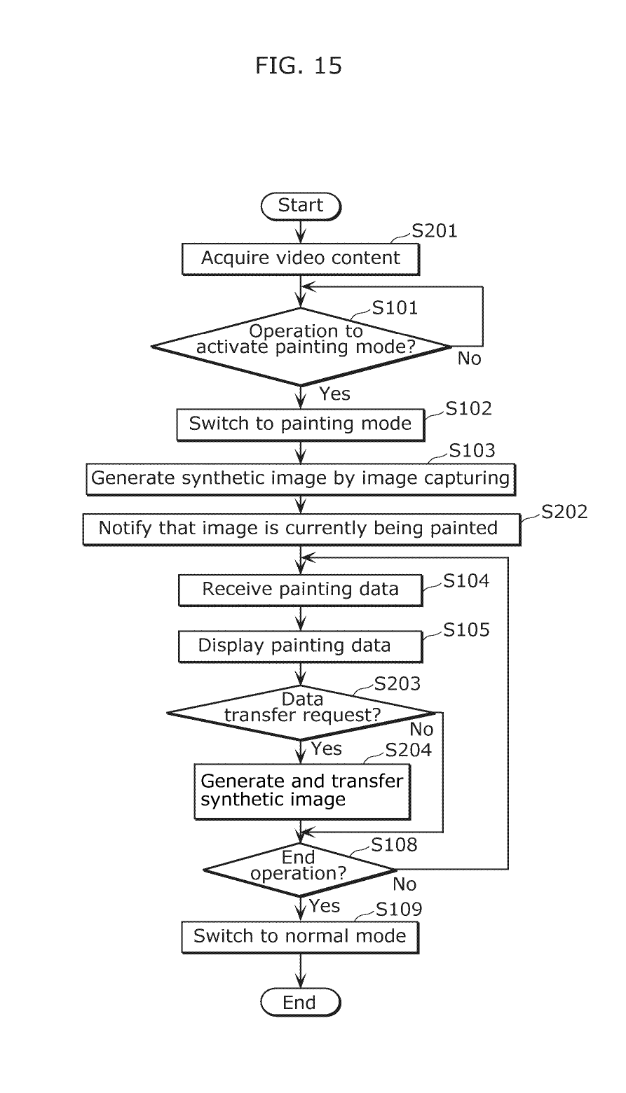

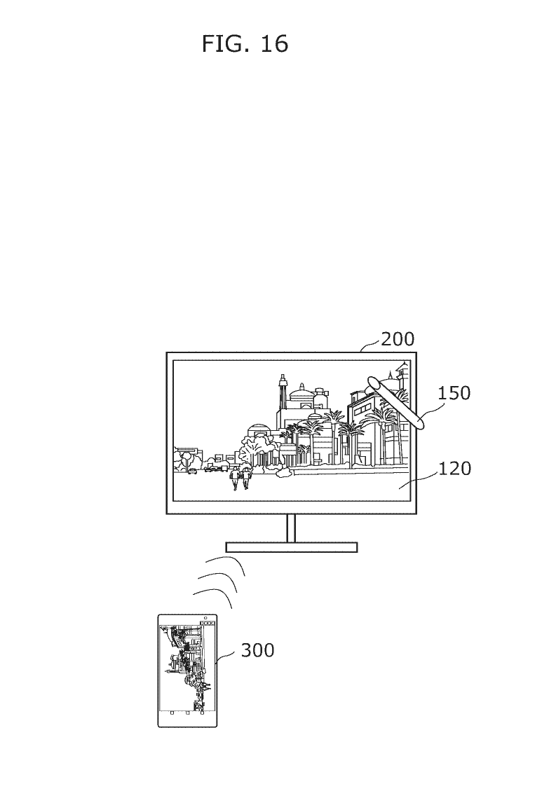

FIG. 15 is a flowchart showing an operation performed by the synthetic image generation apparatus 200 in Embodiment 2. Moreover, each of FIG. 16 to FIG. 19 is a diagram showing an example of the display screen 120 of the synthetic image generation apparatus 200 and the display screen of the terminal device 300 in Embodiment 2. It should be noted that, in the following description, the operation is performed using the input device 150 that has been previously registered by the input-device identification unit 106.

Firstly, the acquisition unit 201 acquires the video content from the external terminal device 300 via the communication unit 204 (Step S201). For example, by the operation performed by the user to transmit the video content currently being displayed on the terminal device 300, the acquisition unit 201 acquires the video content from the terminal device 300. When the acquisition unit 201 acquires the video content from the terminal device 300, the display control unit 202 displays the video content acquired from the terminal device 300 on the display screen 120, as shown in FIG. 16.

Next, the data receiving unit 104 determines whether or not the operation to activate the painting mode is performed by determining, for example, whether or not the display screen 120 is pressed for a few seconds with the tip of the touch pen serving as the input device 150 (Step S101). When the display screen 120 is not pressed for a few seconds by the pen tip (NO in Step S101), the data receiving unit 104 performs nothing in particular. To be more specific, the video content acquired from the terminal device 300 remains to be displayed on the display unit 103 in the normal mode.

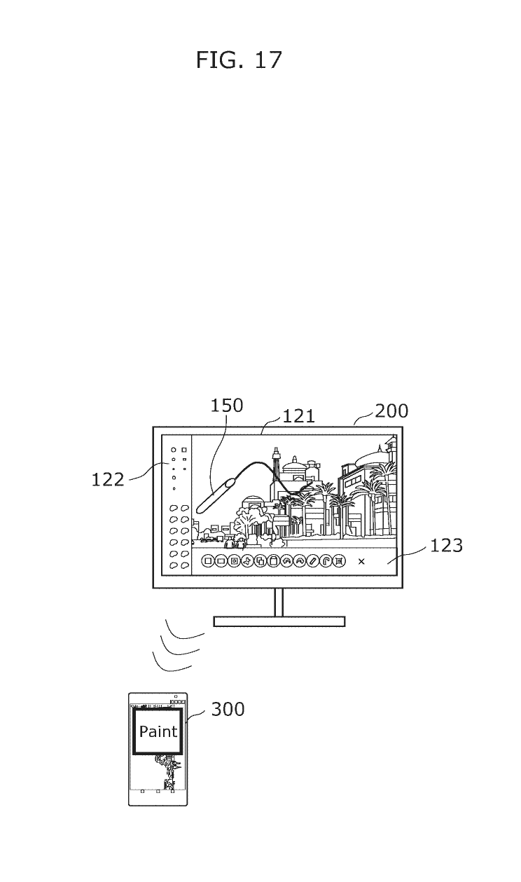

On the other hand, when the display screen 120 is pressed for a few seconds with the pen tip as shown in FIG. 16 (YES in Step S101), the data receiving unit 104 transmits the instruction to activate the painting mode to the display control unit 202 and the synthesis unit 203. When receiving the instruction to activate the painting mode from the data receiving unit 104, the display control unit 202 switches the display mode from the normal mode to the painting mode (Step S102). More specifically, the display control unit 202 displays the video content displayed in the normal mode in a display area 121, as shown in FIG. 17.

Moreover, the display control unit 202 arranges the setting area for setting the information that configures the painting data in the display screen 120. Here, the setting area includes: a palette 122 for setting a line type, a color, a sample image, and so forth; and a toolbar 123 for performing editing operations such as copy, cut, paste, capture, capture cancel, save, and end.

When receiving the instruction to active the painting mode from the data receiving unit 104, the synthesis unit 203 generates a to-be-synthesized image by capturing the to-be-synthesized image from the video content currently being displayed on the display unit 103 (Step S103). Here, the display control unit 202 displays the to-be-synthesized image (the still image) captured by the synthesis unit 203 in the display area 121. To be more specific, immediately after the display mode is switched to the painting mode, the still image instead of the video is displayed in the display area 121.

Next, the synthesis unit 203 notifies the terminal device 300 via the communication unit 204 that the display mode has been switched to the painting mode, that is, that the synthetic image generation apparatus 200 is currently painting an image or the like onto the video content (Step S202). On the display screen of the terminal device 300 receiving this notification, the icon “Paint” is displayed to indicate that the synthetic image generation apparatus 200 is currently in the painting operation, as shown in FIG. 17 for example.

After the display mode is switched to the painting mode, the data receiving unit 104 receives, from the input device 150, the painting data on a painting (an image) painted on the display screen 120 by the user using the input device 150. Here, the data receiving unit 104 receives, from the input device 150, the painting data configured with the line type and the color that are set using the palette 122 (Step S104).

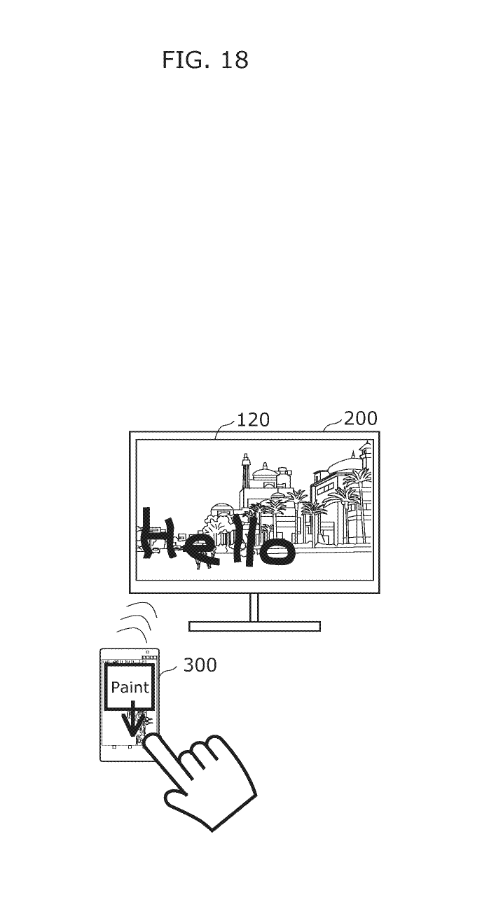

For example, as shown in FIG. 18, the display control unit 202 superimposes the painting data received by the data receiving unit 104 (“Hello” in the example shown in FIG. 18) on the to-be-synthesized image in the display screen 120 (Step S105).

Next, the acquisition unit 201 determines whether or not a synthetic image transfer request is received from the external terminal device 300 via the communication unit 204 (Step S203). When it is determined as a result of the determination that the transfer request is not received (NO in Step S203), the acquisition unit 201 performs nothing in particular.

On the other hand, when the transfer request is received (YES in Step S203), the acquisition unit 201 transmits the transfer request to the synthesis unit 203. The synthesis unit 203 synthesizes the to-be-synthesized image with the painting data received by the data receiving unit 104 to generate the synthetic image, and then transfers the generated synthetic image to the terminal device 300 (Step S204).

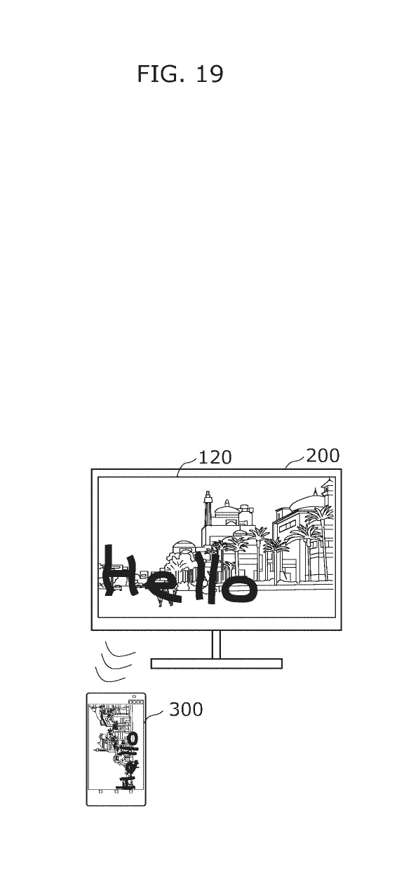

For example, by flicking downward the icon “Paint” displayed on the terminal device 300 as shown in FIG. 18, the user requests the synthetic image generation apparatus 200 to transfer the synthetic image via the terminal device 300. When receiving the transfer request from the terminal device 300, the synthetic image generation apparatus 200 transmits the synthetic image to the terminal device 300. The transferred synthetic image is thus displayed on the terminal device 300 as shown in FIG. 19.

Next, the data receiving unit 104 determines whether or not an end operation is received, by determining whether or not the “end” icon in the toolbar 123 is tapped with the input device 150 (Step S108).

When receiving the end operation (YES in Step S108), the data receiving unit 104 transmits an end instruction to the display control unit 202. When receiving the end instruction from the data receiving unit 104, the display control unit 202 switches the display mode from the painting mode to the normal mode (Step S109). To be more specific, the display control unit 202 displays the video content acquired from the terminal device 300 on the display screen 120 in the normal mode as shown in FIG. 16.

On the other hand, when the end operation is not received (NO in Step S108), the data receiving unit 104 performs noting in particular and returns to receive the painting data again (Step S104). More specifically, the synthetic image generation apparatus 200 remains to receive the painting data from the input device 150 in the painting mode.

As described thus far, the synthetic image generation apparatus 200 acquires the video content stored in the terminal device 300 and generates the to-be-synthesized image from the acquired video content. After this, the synthetic image generation apparatus 200 generates the synthetic image by synthesizing the generated to-be-synthesized image with the painting data received by the data receiving unit 104. Accordingly, the synthetic image generation apparatus 200 can appropriately generate the synthetic image from the video content stored in the external terminal device 300 and the painting data.

It should be noted that, in each of the embodiments described above, the video content broadcasted via digital television broadcasting, the video content stored in the storage unit, or the video content acquired from the external terminal device is synthesized with the painting data. Here, the content to be used for synthesis, save, or transfer is not protected.

Moreover, the embodiments described above may be combined. The operation described in Embodiment 1 may be applied to the video content acquired from the external terminal device. Alternatively, the operation described in Embodiment 2 may be applied to the video content acquired via broadcasting.

Each of the structural elements in each of the embodiments described above may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or a semiconductor memory. Here, the software program for realizing the synthetic image generation apparatus according to each of the embodiments is a program described below.

The program causes a computer to execute: receiving painting data from an input device; synthesizing a still image included in video content with the painting data received in the receiving, to generate a synthetic image; and selectively displaying the video content and the synthetic image on a display device.

Moreover, the synthetic image generation apparatus may be an electronic circuit such as an integrated circuit. The structural elements included in the synthetic image generation apparatus may configure a single circuit or individually separate circuits. Furthermore, each of these structural elements may be a general-purpose circuit or a dedicated circuit.

Moreover, processing performed by a specific structural element included in the synthetic image generation apparatus may be performed by a different structural element. Furthermore, one structural element may include a plurality of structural elements. In addition, the order in which the processes are executed may be changed, and the processes may be executed in parallel.

In the above description, the embodiments have been explained as examples of technology in the present disclosure. For the explanation, the accompanying drawings and detailed description are provided.

On account of this, the structural elements explained in the accompanying drawings and detailed description may include not only the structural elements essential to solve the problem, but also the structural elements that are not essential to solve the problem and are described only to show the above implementation as an example. Thus, even when these nonessential structural elements are described in the accompanying drawings and detailed description, this does not mean that these nonessential structural elements should be readily understood as essential structural elements.

Moreover, the embodiments described above are merely examples for explaining the technology in the present disclosure. On this account, various changes, substitutions, additions, and omissions are possible within the scope of Claims or an equivalent scope.

### INDUSTRIAL APPLICABILITY

The present disclosure is applicable to a synthetic image generation apparatus that generates a synthetic image by synthesizing video content acquired via a broadcast or the like with painting data inputted by a user. To be more specific, the present disclosure is applicable to a plasma display panel television or a liquid crystal display television.

1. A synthetic image generation apparatus comprising:
a receiving unit configured to receive painting data from an input device;
a synthesis unit configured to synthesize a still image included in video content with the painting data received by the receiving unit, to generate a synthetic image; and
a display control unit configured to selectively display the video content and the synthetic image on a display device.

2. The synthetic image generation apparatus according to claim 1,
wherein the synthesis unit is configured to synthesize the still image included in the video content currently being broadcasted with the painting data, to generate the synthetic image, and
the display control unit is configured to selectively display the video content currently being broadcasted and the synthetic image on the display device.

3. The synthetic image generation apparatus according to claim 1,
wherein the receiving unit is configured to repeatedly receive, from the input device, position information indicating a position in a screen of the display device, to receive the painting data indicating an image hand-painted using the input device, and
the synthesis unit is configured to synthesize the still image with the painting data indicating the hand-painted image, to generate the synthetic image.

4. The synthetic image generation apparatus according to claim 1,
wherein the display control unit is configured to
(i) perform effect processing on the video content and display, on the display device, the video content on which the effect processing has been performed, when the video content is to be displayed on the display device, and
(ii) perform the effect processing on the synthetic image and display, on the display device, the synthetic image on which the effect processing has been performed, when the synthetic image is to be displayed on the display device, and
the synthesis unit is configured to synthesize the still image with the painting data to generate the synthetic image, using the still image included in the video content on which the effect processing has not yet been performed.

5. The synthetic image generation apparatus according to claim 1,
wherein the receiving unit is further configured to receive, from the input device, a capture operation by which capturing is performed,
the synthesis unit is configured to
(i) capture the still image from the video content, when the receiving unit receives the capture operation while the video content is being displayed, and
(ii) synthesize the captured still image with the painting data received by the receiving unit, to generate the synthetic image, and
the display control unit is configured to display the synthetic image generated by the synthesis unit, instead of the video content.

6. The synthetic image generation apparatus according to claim 5,
wherein the receiving unit is further configured to receive, from the input device, a capture cancel operation by which capturing is canceled, and
the display control unit is configured to display the video content instead of the synthetic image, when the receiving unit receives the capture cancel operation while the synthetic image is being displayed.

7. The synthetic image generation apparatus according to claim 1,
wherein the synthesis unit is configured to capture the synthetic image from a synthetic video sequence obtained by synthesizing the video content with the painting data, to generate the synthetic image.

8. The synthetic image generation apparatus according to claim 1, further comprising
a storage unit,
wherein the synthesis unit is further configured to store the generated synthetic image into the storage unit.

9. The synthetic image generation apparatus according to claim 1,
wherein the receiving unit is configured to receive the painting data from the input device in a time series,
the synthesis unit is further configured to synthesize, in the time series, the video content with the painting data received by the receiving unit in the time series, to generate a synthetic video sequence, and
the display control unit is further configured to display, on the display device, the synthetic video sequence generated by the synthesis unit.

10. The synthetic image generation apparatus according to claim 1, further comprising
a storage unit,
wherein the receiving unit is configured to receive the painting data from the input device in a time series and store, as painting video data, the painting data received in the time series into the storage unit in the time series,
the synthesis unit is further configured to synthesize the video content with the painting video data stored in the storage unit, to generate a synthetic video sequence, and
the display control unit is further configured to display the synthetic video sequence generated by the synthesis unit on the display device.

11. The synthetic image generation apparatus according to claim 1, further comprising
an acquisition unit configured to acquire the video content from an external terminal device via a network,
wherein the synthesis unit is configured to synthesize the still image included in the video content acquired by the acquisition unit with the painting data received by the receiving unit, to generate the synthetic image.

12. The synthetic image generation apparatus according to claim 11,
wherein the synthesis unit is further configured to output the generated synthetic image to the terminal device.

13. The synthetic image generation apparatus according to claim 1,
wherein the receiving unit is further configured to
(i) receive, from the input device, a painting start operation by which painting is started, and
(ii) receive position information indicating a position in a screen of the display device from the input device to receive the painting data corresponding to the position, after the painting start operation is received, and
the display control unit is configured to arrange a setting area and a display area in the screen when the receiving unit receives the painting start operation, the setting area being used for setting information that configures the painting data, and the display area being used for displaying the video content.

14. The synthetic image generation apparatus according to claim 13,
wherein the setting area is used for setting, as the information that configures the painting data, information on at least one of a line, a color, and a sample image, and
the receiving unit is further configured to (i) set the information on at least one of the line, the color, and the sample image by receiving, from the input device, the position information indicating the position in the setting area and (ii) receive the painting data configured with the set information.

15. The synthetic image generation apparatus according to claim 13,
wherein the display control unit is configured to determine an arrangement position of the setting area according to the position information received from the input device, and arrange the setting area in the determined arrangement position.

16. The synthetic image generation apparatus according to claim 1,
wherein the receiving unit is configured to receive the painting data from a plurality of input devices including the input device, and
the synthesis unit is configured to synthesize the still image included in the video content with the painting data received by the receiving unit from the input devices, to generate the synthetic image.

17. The synthetic image generation apparatus according to claim 1, further comprising the input device.

18. The synthetic image generation apparatus according to claim 1, further comprising the display device.

19. A broadcast receiving apparatus comprising:
the synthetic image generation apparatus according to claim 18; and
a tuner which acquires the video content, by receiving a digital television broadcast signal and demodulating the received digital television broadcast signal.

20. A synthetic image generation method comprising:
receiving painting data from an input device;
synthesizing a still image included in video content with the painting data received in the receiving, to generate a synthetic image; and
selectively displaying the video content and the synthetic image on a display device.
